(19) United States
(12) Patent Application Publication
(10) Pub. No.: US 2014/0159402 A1
(43) Pub. Date: Jun. 12, 2014

(54) PHONE/TABLET HOLDER

(71) Applicant: Hugo Madrid, Lawrenceville, GA (US)

(72) Inventor: Hugo Madrid, Lawrenceville, GA (US)

(21) Appl. No.: 14/099,616

(22) Filed: Dec. 6, 2013

Related U.S. Application Data
(60) Provisional application No. 61/734,263, filed on Dec. 6, 2012.

(51) Int. Cl. H04M 1/02

(52) U.S. Cl. CPC H04M 1/0279
USPC 294/137

(57) ABSTRACT

Implementations of a holder for handheld devices such as mobile phones and tablets are provided. In some implementations, the holder includes a first piece of fabric-like material having adhesive on a first side for securing the first side to a hand-held device. In some implementations, the other side of the fabric-like material may include either hooks or loops (e.g., like the hooks or loops of Velcro® fasteners). In some implementations, the holder may also include two circular-shaped disks rotatably connected to each other. In some implementations the disks are any shape. In some implementations, the outer surface of one of the disks includes either hooks or loops to attach to the loops or hooks, respectively, of the fabric-like material attached to the handheld device. In this way, when the disks are secured to the fabric-like material attached to the handheld device, the handheld device may be rotated.

### CROSS REFERENCE TO RELATED APPLICATION

This application claims the benefit of U.S. Patent Application Ser. No. 61/734,263, which was filed on Dec. 6, 2012, and is incorporated herein by reference in its entirety.

### TECHNICAL FIELD

This disclosure relates to a holder for handheld devices such as mobile phones and tablets.

### BACKGROUND

Cell phones, tablets, and other handheld devices are rapidly gaining popularity with consumers and are nearly ubiquitous. Watching movies, reading e-mail, and surfing the web are just a few of the routine ways these devices are used. It is often desirous to use the screen rotation feature of these devices. In other instances, it may be difficult to operate the keyboard or touch screen functions of these devices because both hands are required simply to hold the device.

U.S. Patent Application Publication No. 2012/0048873 (“'873 patent”) discloses an electronic device case gripper for use with portable electronic devices. The case gripper is comprised of a case which holds the portable electronic device therein and an attached strap. The '873 patent discloses that the strap may be secured about the users hand and the case rotated thereabout.

However, the case gripper disclosed in the '873 patent has several disadvantages. First, it is not universal; that is, it is not designed to be capable of fitting on different handheld devices of different dimensions. Second, it is relatively bulky and complex in construction and/or operation.

### BRIEF DESCRIPTION OF THE DRAWINGS

FIGS. 1A-C illustrate a first example embodiment of a handheld device holder of the present disclosure.

FIGS. 2A and 2B illustrate a method of using the handheld device holder.

FIGS. 3A and 3B illustrate a second example embodiment of a handheld device holder of the present disclosure.

### DETAILED DESCRIPTION

Implementations of a holder for handheld devices such as mobile phones and tablets are provided. In some implementations, the holder includes a first piece of fabric-like material having adhesive on a first side for securing the first side to a hand-held device. In some implementations, the other side of the fabric-like material may include either hooks or loops (e.g., like the hooks or loops of Velcro® fasteners).

In some implementations, the holder may also include two circular-shaped disks rotatably connected to each other. In some implementations, the disks are any shape. In some implementations, the outer surface of one of the disks includes either hooks or loops to attach to the loops or hooks, respectively, of the fabric-like material attached to the handheld device. In this way, when the disks are secured to the fabric-like material attached to the handheld device, the handheld device may be rotated.

In some implementations, one of the disks may have an adjustable strap attached thereto. In some implementations, one of the disks may have a first strap to receive a user's figures and additionally includes a second strap for receiving a user's thumb. In some implementations, both the first strap and the second strap can be adjustable.

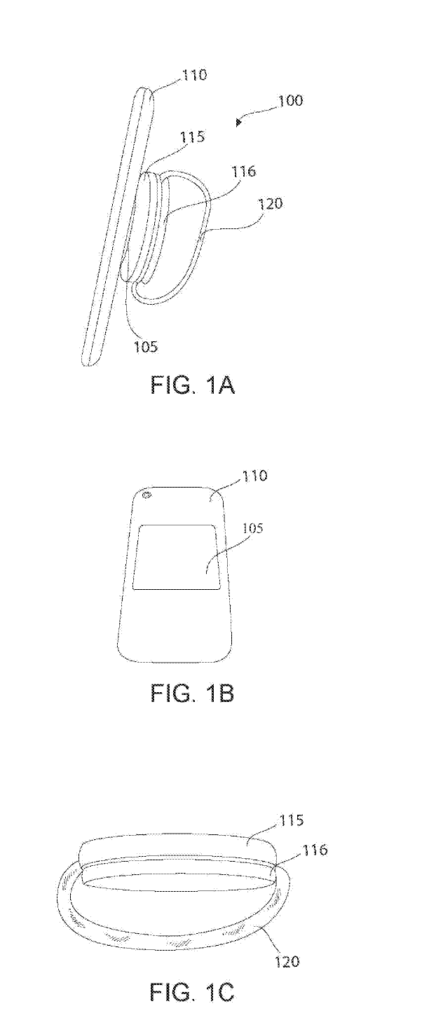

FIGS. 1A-C illustrate a first example embodiment of a handheld device holder 100 of the present disclosure. The holder 100 includes a first piece of fabric-like material 105 (see FIG. 1B) having adhesive on a first side for securing the first side to a hand-held device 110. The other side of the fabric-like material 105 includes either hooks or loops (e.g., like the hooks or loops of Velcro® fasteners). The first piece of fabric-like material 105 can be any size or shape. As shown in FIG. 1B, the material is a generally square shape.

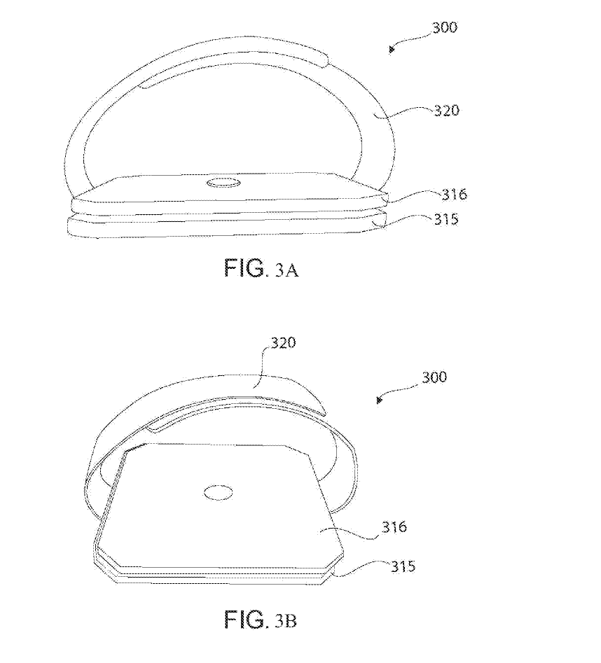

The holder 100 also includes two circular-shaped disks 115,116 rotatably connected to each other as shown in FIG. 1C. In some implementations, the disks may be attached to each other with a fastener (see FIGS. 3A and 3B) or any known, or future developed device. One of ordinary skill in the art, with the benefit of this disclosure, would know how to rotatably connect the two disks 115,116. In some implementations, the disks 115,116 are any shape. The outer surface of one of the disks (e.g., disk 115) (i.e., the first disk) includes either hooks or loops to attach to the loops or hooks, respectively, of the fabric-like material 105 attached to the handheld device as shown in FIG. 1A.

The adjustable strap 120 can be attached to the disks 115,116 construction in any manner presently known or future developed. One of ordinary skill in the art, with the benefit of this disclosure, would know how to attach the strap 120 to the disks 115,116 construction. For example, one part of the strap 120 can be positioned between the disks 115,116 and the disks and strap can be secured together with a screw that goes through the center of both disk (see, e.g., FIG. 3A).

In some implementations, the adjustable strap 120 includes a strip of material having hooks on a first side and loops on a second side. In this way, the two ends of the strip of material can overlap and connect to form a closed loop as shown in FIG. 3A. To adjust the strap 120, the extent to which the two ends of the strip of material overlap is adjusted. The adjustable straps 120 can be implemented in other ways currently known or invented in the future.

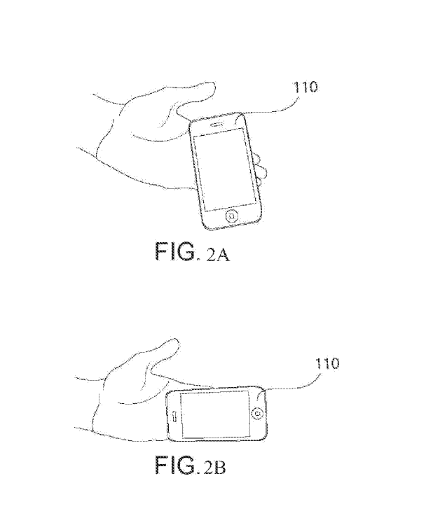

In this way, when the disks 115,116 are secured to the fabric-like material 105 attached to the handheld device 110 as shown in FIG. 1A, a user can insert figures through the loop and then rotate the handheld device 110 as shown in FIGS. 2A-2B.

In some implementations, the disks 115,116 are made out of plastics. In some implementations, the disks 115,116 are made out of any other material.

FIGS. 3A and 3B illustrate a second example embodiment of a handheld device holder 300 of the present disclosure having non-circular disk 315,316. In some embodiments, the holder 300 may have an adjustable strap 320.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of 100 the invention can be practiced without one or more of the specific details, or with other methods, components, materials, etc. In other instances, well-known structures, materials, or operations may not be shown or described in detail.

1. A handheld device holder comprising:
a first piece of material having an adhesive on a first side and either hooks or loops on a second side;
a first retainer piece and a second retainer piece that are rotatably connected to each other, said first retainer piece includes either hooks or loops on an outer surface;
wherein the hooks or loops on said outer surface of said first retainer piece are selected to attach to the hooks or loops, respectively, of said first piece of material, and;
an adjustable strap configured to form a closed loop.

2. The holder of claim 2 further comprising a second strap, said second strap is configured to form a close loop configured to receive a thumb.

3. A method of using the handheld device holder of claim 1, the method comprising:
securing said first piece of material to a handheld device using the adhesive on said first side;
securing said first retainer piece to said first piece of material using the provided hooks and loops;

4. The method of claim 3 wherein a user slides their fingers through said first strap and adjust said first strap to a comfortable fit about the fingers.

5. The method of claim 3 wherein a user may rotate the handheld device using the holder of claim 1.
